(19) United States
(12) Patent Application Publication
(10) Pub. No.: US 2026/0002102 A1
(43) Pub. Date: Jan. 1, 2026

(54) METHODS AND SYSTEMS FOR THE RECOVERY OF POLAR AND NON-POLAR AROMA COMPOUNDS FROM A DEALCOHOLIZED BEVERAGE

(71) Applicant: FLAVOLOGIC GMBH, Vaterstetten (DE)

(72) Inventors: Alexander HÄSSELBARTH, Vaterstetten (DE); Claudia GEYER, Grafing b. Munchen (DE)

(73) Assignee: FLAVOLOGIC GMBH, Vaterstetten (DE)

(21) Appl. No.: 19/319,592

(22) Filed: Sep. 4, 2025

Related U.S. Application Data
(63) Continuation of application No. PCT/IB2024/059767, filed on Oct. 6, 2024.
(60) Provisional application No. 63/588,328, filed on Oct. 6, 2023.
(60) Provisional application No. 63/588,448, filed on Oct. 6, 2023.

(51) Int. Cl. C12C 12/04; A23L 2/56; A23L 2/64; A23L 5/20; C12G 1/14; C12H 3/00

(52) U.S. Cl. CPC C12C 12/04; A23L 2/56; A23L 2/64; A23L 5/273; C12G 1/14; C12H 3/00

(57) ABSTRACT

The present invention provides a drinkable article prepared from an alcoholic beverage comprising 0.045% ethanol by volume or less, wherein the drinkable article is characterized by having an amount of innate volatile organic compounds (VOC); and, wherein the amount of innate VOC comprises a plurality of innate aroma compounds; and wherein MeOH contents in the drinkable article is at least one of:
a. under the detection level, when measured by Procedure A;
b. less than 0.01% by volume; and,
   wherein the ratio of EtAc to the amount of innate VOC in the drinkable article is between 1:0.2 and 1:300, when measured according to Procedure B.

### CROSS-REFERENCE TO RELATED APPLICATIONS

This application is a continuation of PCT International Application No. PCT/IB2024/059767, filed Oct. 6, 2024, claiming the benefit of U.S. Provisional Application No. 63/588,328, filed Oct. 6, 2023, and U.S. Provisional Application No. 63/588,448, filed Oct. 6, 2023, the contents of each of which are hereby incorporated by reference into the subject application.

### FIELD OF THE INVENTION

The invention relates to the field of food and beverage. More specifically, the invention relates to drinkable articles having low/no alcohol having desirable taste and aroma profile and methods for doing the same.

### BACKGROUND OF THE INVENTION

A demand for low-alcohol or dealcoholized version of alcoholic or fermented beverages is constantly increasing. While the immediate reason for this phenomenon stems from the harmful effect of excessive alcohol consumption leading to serious issues including alcoholism, but also leads to other serious issues, including domestic violence and traffic accidents due to drunk driving, millions refrain from consuming alcohol due to cultural or religious reasons.

Wine, similarly, to many other popular fermented alcohol-containing drinks, has over 1000 different aroma or flavor compounds, with approximately 400 produced during fermentation. Dealcoholizing has been shown to remove some of the volatile compounds, affecting the flavor of the low-alcohol product (Food, 2021).

One of the biggest challenges of the industry is to preserve innate taste and the aroma in the low/no alcoholic versions of the popular drinks, and to allow the consumer to have a true “drinking experience”.

Production of alcohol-free beverages having innate aroma and taste experience similar to that, of the original alcohol-containing products, remains a long and unmet need.

### SUMMARY OF THE INVENTION

It is a principal object of the present invention to provide low/no alcoholic versions of the popular drinks having an innate taste and aroma, and to allow the consumer to have a true “drinking experience”.

According to some embodiments, the invention provides a drinkable article prepared from an alcoholic beverage comprising 0.045% ethanol by volume or less, wherein the drinkable article is characterized by having an amount of innate volatile organic compounds (VOC); and, wherein the amount of innate VOC comprises a plurality of innate aroma compounds; and wherein MeOH content in the drinkable article is at least one of:
a. under the detection level, when measured by Procedure A;
b. less than 0.01% by volume; and,
   wherein the ratio of EtAc to the amount of innate median VOC(20) in the drinkable article is between 1:0.2 and 1:300.

According to some embodiments, the invention provides a drinkable article prepared from an alcoholic beverage comprising 0.045% ethanol by volume or less, wherein the drinkable article is characterized by having an amount of innate volatile organic compounds (VOC); and wherein the amount of innate VOC comprises a plurality of innate aroma compounds, and wherein MeOH content in the drinkable article is under the detection when measured by Procedure A and/or less than 0.01% by volume; and, wherein the drinkable article is characterized by at least one of the following:
a. an EtAc-to-Hexanoic acid ratio in the range of 1:0.02 to 1:250;
b. an EtAc-to-Phenylethyl Alcohol ratio in the range of 1:0.01 to 1:245;
c. an EtAc-to-Octanoic acid ratio in the range of 1:0.3 to 1:300;
d. an EtAc-to-Nonanoic acid ratio in the range of 1:0.1 to 1:100; and
e. an EtAc-to-Decanoic acid ratio in the range of 1:0.3 to 1:320.
   wherein said ratio is measured according to Procedure B.

According to some embodiments, the invention provides a drinkable article prepared from an alcoholic beverage comprising 0.045% ethanol by volume or less, wherein the drinkable article is characterized by having an amount of innate volatile organic compounds (VOC); and, wherein the amount of innate VOC comprises a plurality of innate aroma compounds; and wherein MeOH content in the drinkable article is at least one of:
c. under the detection level, when measured by Procedure A;
d. less than 0.01% by volume; and,
   wherein the innate VOC comprises at least 70% of the plurality of the innate aroma compounds in the alcoholic beverage the drinkable article is made of.

According to some embodiments, the invention provides a process for the preparation of a drinkable article according to the embodiments of the invention, the process comprising:
a. recovering at least the majority of the plurality of innate aroma compounds of the VOC from the alcoholic beverage; and
b. preparing the drinkable article comprising the amount VOC comprising the plurality of innate aroma compounds,
   wherein the step of recovering the plurality of aroma compounds from the alcoholic beverage comprises at least a pre-concentration and a concentration steps, wherein the pre-concentration step comprises preparing a pre-concentrate comprising the plurality of aroma compounds from a starting material originating from the alcoholic beverage; and, wherein the concentration step comprises preparing a concentrate comprising the plurality of aroma compounds from the pre-concentrate; and wherein each of the pre-concentration and the concentration steps comprises at least one cycle of: adsorption on at least one column loaded with an adsorbent agent that binds at least the majority of the plurality of innate aroma compounds; and, desorption of the plurality of innate aroma compounds from the at least one column with a desorption agent.

According to some embodiments, the invention provides process for the preparation of a drinkable article according to the embodiments of the invention, comprising the steps of:
a. providing a starting material having at most 50% ethanol by volume, wherein the starting material originates from an alcoholic beverage and comprises an amount of VOC comprising a plurality of innate aroma compounds of the alcoholic beverage;
b. preparing a concentrate comprising the plurality of innate aroma compounds,
c. obtaining the drinkable article comprising the amount of VOC comprising the plurality of innate aroma compounds from the concentrate of step b.

### DETAILED DESCRIPTION OF THE INVENTION

Before explaining at least one embodiment of the invention in detail, it is to be understood that the invention is not limited in its application to the details of construction and the arrangement of the components set forth in the following description. The invention is applicable to other embodiments or of being practiced or carried out in various ways. Also, it is to be understood that the phraseology and terminology employed herein is for the purpose of description and should not be regarded as limiting.

According to some embodiments, the invention provides a drinkable article having low alcohol content.

According to some embodiments, the invention provides a drinkable article free of alcohol.

In the context of the invention, beverages coupled to such terms as “Low alcohol” and/or “no alcohol” are considered to have lower alcohol strength or concentration than the standard alcoholic beverages. The exact definition of the above term may vary in different territories, and thus should not be considered and/or construed as limiting.

In the context of the invention the term “alcohol strength” when used in connection with an alcoholic beverage, refers, without limitation to the “ethanol concentration”—or specifically the ethanol concentration by volume. The above definition may be interchangeable with the terms “% vol.” (which may be preceded by the word “alcohol” or an abbreviation “alc”) or “alcohol by volume” or “ethanol by volume” or ABV or % ABV. ABV is commonly calculated as the volume (in milliliters) of alcohol (or ethanol) in 100 milliliters (at 20° C.).

In the context of the embodiments of the invention, the term “low alcohol” when related to beverages, can be interpreted, without limitation, as beverages having less than 1.2 ABV.

In the context of the invention the term “no alcohol” when related to beverages, can be understood, without limitation, a beverage having ≤0.5% ethanol by volume. Alternatively, and/or additionally, the above terms may refer, without limitation, to a subcategory of “no alcohol” beverages having ≤0.04% ethanol by volume.

In the context of the invention, the term “drinkable article” is interchangeable with the term “beverage” and refers to any drink other than water.

According to some embodiments, the above drinkable article has 0.045% ethanol by volume or less, and prepared from an alcoholic beverage, said alcoholic beverage comprising a plurality of innate aroma compounds, wherein the Methanol (MeOH) content of the drinkable article is at least 10 times lower times lower than the methanol content of the alcoholic beverage, and wherein the drinkable article comprises at least 70% of the plurality of innate aroma compounds of the alcoholic beverage the drinkable article is prepared from. According to some embodiments, the Methanol (MeOH) content of the drinkable article is at least 100 times lower than the methanol content of the alcoholic beverage. According to some embodiments, the Methanol (MeOH) content of the drinkable article is at least 1000 times lower than the methanol content of the alcoholic beverage. According to some embodiments, the Methanol (MeOH) content of the drinkable article is at least 10000 times lower than the methanol content of the alcoholic beverage. According to some embodiments, the Methanol (MeOH) content of the drinkable article is between 10 and 10000 times lower than the methanol content of the alcoholic beverage.

According to some embodiments, the above drinkable article has 0.045% ethanol by volume or less, wherein the drinkable article is prepared from an alcoholic beverage and characterized by having an amount of innate volatile organic compounds (VOC), when measured by Procedure B; and wherein VOC comprises a plurality of innate aroma compounds; and wherein Methanol (MeOH) content in the drinkable article is under the detection level, when measured by Procedure A; and wherein the ratio of Ethyl Acetate (EtAc) to the median VOC(20) is between 0.2 and 1:300.

As used herein the term “volatile organic compounds” (VOC) refers to organic compounds that have a high vapor pressure at room temperature. Some VOCs are further characterized as aroma compounds, as being sufficiently volatile to access the olfactory system.

VOCs are commonly analyzed using Gas Chromatography, often combined with a Mass Spectroscopy (GCMS), Headspace Solid Phase Microextraction and Gas Chromatography-tandem Mass Spectrometry (HS-SPME-GC-MS/MS) or HS-GC-flame ionization detector (FID).

In the context of the invention the term “VOC(20)” refers to the 20 most abundant VOCs in a sample detected using Procedure B, omitting the peaks associated with ethyl acetate (EtAc), ethanol (EtOH), methanol, methylene chloride, analytical artefacts, or contaminants introduced or generated by or during sample preparation or during sample measurement into account. In the context of the invention the term “median VOC(20)” refers to the calculated median of the VOC(20) and the term “total VOC(20)” refers to the total amount of VOC(20).

According to some embodiments, the drinkable article according to any of the above has a ratio of EtAc to the amount of innate median VOC(20) of between 0.5 and 1:200.

According to some embodiments, the drinkable article according to any of the above has a ratio of EtAc to the amount of innate median VOC(20) of between 1:1 and 1:125.

According to some embodiments, the drinkable article according to any of the above has a ratio of EtAc to the amount of innate median VOC(20) of between 1:2 and 1:75.

According to some embodiments, the drinkable article according to any of the above has a ratio of EtAc to the amount of innate median VOC(20) of between 1:3 and 1:50.

According to some embodiments, the drinkable article according to any of the above has a ratio of EtAc to the amount of innate median VOC(20) of between 1:4 and 1:25.

According to some embodiments, the drinkable article according to any of the above has a ratio of EtAc to the amount of innate median VOC(20) of between 1:5 and 1:15.

According to some embodiments, the drinkable article according to any of the above comprises less than 50 ppm EtAc.

According to some embodiments, the drinkable article according to any of the above has an innate total VOC(20) of at least 100 ppm.

In the context of the invention the VOC ppm is calculated in ppm DMOT (m/z 154) equivalents, as related to the peak area of DMOT.

According to some embodiments, the drinkable article according to any of the above has an innate total VOC(20) of at least 150 ppm.

According to some embodiments, the drinkable article according to any of the above has at least 10 innate VOC at a concentration of at least 1 ppm.

According to some embodiments, the drinkable article according to any of the above has at least 10 innate VOC at a concentration of at least 2 ppm.

According to some embodiments, the drinkable article according to any of the above has at least 10 innate VOC at a concentration of at least 2 ppm.

According to some embodiments, the above drinkable article has the same flavor signature as the alcoholic beverage, before the dealcoholizing process. According to some embodiments, the above drinkable article has no additional flavorings and/or colorings.

In the context of the embodiments of the invention, the term “added flavor”, “additional flavorings”, or “additional colorings”, when related to dealcoholized beverage, refers to any flavor or color compound(s) added to the dealcoholized beverage not found in, or extracted from, the alcoholic beverage. Terms like “natural flavorings”, “extract” or “natural colorings” are often used to disclose the addition of flavorings or colorings to alcohol-free beverages.

According to some embodiments, the above drinkable article has 0.045% ethanol by volume or less wherein the drinkable article is prepared from an alcoholic beverage and characterized by having an amount of innate volatile organic compounds (VOC); and wherein MeOH content in the drinkable article is under the detection when measured by Procedure A, and characterized by at least one of the following:
1. an EtAc-to-Hexanoic acid ratio in the range of 1:0.02 to 1:250;
2. an EtAc-to-Phenylethyl Alcohol ratio in the range of 1:0.01 to 1:245;
3. an EtAc-to-Octanoic acid ratio in the range of 1:0.3 to 1:300;
4. an EtAc-to-Nonanoic acid ratio in the range of 1:0.1 to 1:100; and
5. an EtAc-to-Decanoic acid ratio in the range of 1:0.3 to 1:320;

According to some embodiments, the above drinkable article has an EtAc-to-Hexanoic acid ratio of 1:0.004 to 1:150.

According to some embodiments, the above drinkable article has an EtAc-to-Hexanoic acid ratio of 1:0.01 to 1:100.

According to some embodiments, the above drinkable article has an EtAc-to-Hexanoic acid ratio of 1:0.05 to 1:75.

According to some embodiments, the above drinkable article has an EtAc-to-Hexanoic acid ratio of 1:0.1 to 1:50.

According to some embodiments, the above drinkable article has an EtAc-to-Hexanoic acid ratio of 1:0.5 to 1:25.

According to some embodiments, the above drinkable article has an EtAc-to-Phenylethyl Alcohol ratio of 1:0.004 to 1:150.

According to some embodiments, the above drinkable article has an EtAc-to-Phenylethyl Alcohol ratio of 1:0.05 to 1:75.

According to some embodiments, the above drinkable article has an EtAc-to-Phenylethyl Alcohol ratio of 1:0.1 to 1:50.

According to some embodiments, the above drinkable article has an EtAc-to-Phenylethyl Alcohol ratio of 1:0.3 to 1:15.

According to some embodiments, the above drinkable article has an EtAc-to-Octanoic acid ratio of 1:0.0035 to 1:150.

According to some embodiments, the above drinkable article has an EtAc-to-Octanoic acid ratio of 1:0.005 to 1:75.

According to some embodiments, the above drinkable article has an EtAc-to-Octanoic acid ratio of 1:0.1 to 1:50.

According to some embodiments, the above drinkable article has an EtAc-to-Octanoic acid ratio of 1:0.25 to 1:15.

According to some embodiments, the above drinkable article has an EtAc-to-Nonanoic acid ratio of 1:0.01 to 1:50.

According to some embodiments, the above drinkable article has an EtAc-to-Nonanoic acid ratio of 1:0.03 to 1:25.

According to some embodiments, the above drinkable article has an EtAc-to-Nonanoic acid ratio of 1:0.05 to 150.

According to some embodiments, the above drinkable article has an EtAc-to-Nonanoic acid ratio of 1:0.1 to 1:75.

According to some embodiments, the above drinkable article has an EtAc-to-Decanoic acid ratio of 1:0.01 to 1:15.

According to some embodiments, the above drinkable article has an EtAc-to-Decanoic acid ratio of 1:0.01 to 1:7.5.

According to some embodiments, the above drinkable article has an EtAc-to-Decanoic acid ratio of 1:0.2 to 1:5.

According to some embodiments, the above drinkable article has an EtAc-to-Decanoic acid ratio of 1:0.5 to 1:1.

As used herein the term “aroma compounds” (also referred to as odorants, aroma, fragrances, or flavoring) refers, without limitation, to chemical compounds or substances that have a smell or odor. The aroma compounds affect the sensory impression of a beverage, mainly the flavor and aroma. Many of the aroma compounds in alcoholic beverages are, without limitation, a product of fermentation process and/or an aging process. A non-limiting list of aroma compounds in beverages of the invention includes Geraniol, (Z)-3-Hexenal, beta-Ionone, (R)-Linalool, Myrcene, Nonanal, (R)-a-Pinene, ethyl 3-methylbutanoate, Hexanal, and 1,8-Cineole, ethyl acetate, butyric acid ethyl ester, Isobutanol, Isoamyl acetate, 2-Methylbutan-1-ol, 3-Methylbutan-1-ol, Ethyl hexanoate, 2-phenylethyl acetate, 2-phenylethanol, or any combination thereof. 2-methylbutan-1-ol and/or 3-methylbutan-1-ol are preferred.

In the context of the invention, the phrase “innate aroma compounds” is meant to be understood as aroma compounds originally present in the alcoholic beverage the drinkable articles of the invention were prepared from.

Throughout this application, the above and the foregoing embodiments of the application, the phrase “a plurality of innate aroma compounds” should be read, interpreted, understood and/or construed as a group of aroma compounds which does not comprise methanol.

According to the above and the foregoing embodiments of the application, it should be understood that the plurality of innate aroma compounds in the drinkable articles, starting material, pre-concentrates and concentrates of the invention comprise at least a majority of such innate aroma compounds, and not all the aroma compounds present in the alcoholic beverage such drinkable articles, starting material, pre-concentrates and concentrates are prepared from.

According to some embodiments the invention provides a drinkable article having 0.045% ABV or ethanol (EtOH) by volume or less prepared from an alcoholic beverage and characterized by having an amount of innate volatile organic compounds (VOC); wherein the amount of innate VOC comprises a plurality of innate aroma compounds; and wherein the drinkable article comprises at least 70% of the innate VOC of the alcoholic beverage it is made of; and, wherein the Methanol (MeOH) content in the drinkable article is under the detection level, when measured by Procedure A; and wherein ratio of EtOH % by volume to the amount of innate median VOC(20) to in the drinkable article is between 5 to 15000, when measured by Procedure B; and wherein, the drinkable article comprises no added flavor.

According to some embodiments, the above drinkable article has ratio of % EtOH by volume to the amount of innate median VOC(20) to in the drinkable article is between 15 to 5000.

According to some embodiments, the above drinkable article has ratio of % EtOH by volume to the amount of innate median VOC(20) to in the drinkable article is between 25 to 1500.

According to some embodiments, the above drinkable article has ratio of % EtOH by volume to the amount of innate median VOC(20) to in the drinkable article is between 50 to 1000.

According to some embodiments, the above drinkable article has ratio of % EtOH by volume to the amount of innate median VOC(20) to in the drinkable article is between 100 to 500.

According to some embodiments, a drinkable article according to any of the above comprises 0.01% ethanol by volume or less.

According to some embodiments, a drinkable article according to any of the above comprises 0.0045% ethanol by volume or less.

According to some embodiments, the above drinkable article, has ethanol content of 0.045% by vol., 0.044% by vol., 0.043% by vol., 0.042% by vol., 0.041% by vol., 0.040% by vol., 0.039% by vol., 0.038% by vol., 0.037% by vol., 0.036% by vol., 0.035% by vol., 0.034% by vol., 0.033% by vol., 0.032% by vol., 0.031% by vol., 0.030% by vol., 0.029% by vol., 0.028% by vol., 0.027% by vol., 0.026% by vol., 0.025% by vol., 0.024% by vol., 0.023% by vol., 0.022% by vol., 0.021% by vol., 0.020% by vol., 0.019% by vol., 0.018% by vol., 0.017% by vol., 0.016% by vol., 0.015% by vol., 0.014% by vol., 0.013% by vol., 0.012% by vol., 0.011% by vol., 0.010% by vol., 0.009% by vol., 0.008% by vol., 0.007% by vol., 0.006% by vol., 0.005% by vol., 0.004% by vol., 0.003% by vol., 0.002% by vol., 0.001% by vol. or less, or can have or can be completely ethanol-free.

According to some embodiments, the above drinkable article has no detectable methanol, as measured according to Procedure A.

According to some embodiments, the above drinkable article, has methanol content of 0.010% by vol., 0.009% by vol., 0.008% by vol., 0.007% by vol., 0.006% by vol., 0.005% by vol., 0.004% by vol., 0.003% by vol., 0.002% by vol., 0.001% by vol. or less, or can have or can be completely methanol-free.

According to some embodiments of the above drinkable article, when the ethanol content of the alcoholic beverage the drinkable articles of the invention were prepared from is between 3% to 50% ethanol by vol., the methanol content of the drinkable article is from about 100 times to about 1500 times lower than the methanol content of the alcoholic beverage the drinkable article is prepared from.

According to some embodiments of the above drinkable article, when the ethanol content of the alcoholic beverage the drinkable articles of the invention were prepared from is 3.0% by vol., 3.5% by vol., 4.0% by vol., 4.5% by vol., 5.0% by vol., 5.5% by vol., 6.0% by vol., 6.5% by vol., 7.0% by vol., 7.5% by vol., 8.0% by vol., 8.5% by vol., 9.0% by vol., 9.5% by vol., 10.0% by vol., 10.5% by vol., 11.0% by vol., 11.5% by vol., 12.0% by vol., 12.5% by vol., 13.0% by vol., 13.5% by vol., 14.0% by vol., 14.5% by vol., 15.0% by vol., 15.5% by vol., 16.0% by vol., 16.5% by vol., 17.0% by vol., 17.5% by vol., 18.0% by vol., 18.5% by vol., 19.0% by vol., 19.5% by vol., 20.0% by vol., 20.5% by vol., 21.0% by vol., 21.5% by vol., 22.0% by vol., 22.5% by vol., 23.0% by vol., 23.5% by vol., 24.0% by vol., 24.5% by vol., 25.0% by vol., 25.5% by vol., 26.0% by vol., 26.5% by vol., 27.0% by vol., 27.5% by vol., 28.0% by vol., 28.5% by vol., 29.0% by vol., 29.5% by vol., 30.0% by vol., 30.5% by vol., 31.0% by vol., 31.5% by vol., 32.0% by vol., 32.5% by vol., 33.0% by vol., 33.5% by vol., 34.0% by vol., 34.5% by vol., 35.0% by vol., 35.5% by vol., 36.0% by vol., 36.5% by vol., 37.0% by vol., 37.5% by vol., 38.0% by vol., 38.5% by vol., 39.0% by vol., 39.5% by vol., 40.0% by vol., 40.5% by vol., 41.0% by vol., 41.5% by vol., 42.0% by vol., 42.5% by vol., 43.0% by vol., 43.5% by vol., 44.0% by vol., 44.5% by vol., 45.0% by vol., 45.5% by vol., 46.0% by vol., 46.5% by vol., 47.0% by vol., 47.5% by vol., 48.0% by vol., 48.5% by vol., 49.0% by vol., 49.5% by vol. or 50.0% by vol., the methanol content of the drinkable article is from about 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500 times lower than the methanol content of the alcoholic beverage the drinkable article is prepared from.

According to some embodiments of the above drinkable article, at least a portion of the plurality of innate aroma compounds in the drinkable article have a log Pow of between 0.7 to 3.5.

According to some embodiments of the above drinkable article, at least a portion of the plurality of innate aroma compounds in the drinkable article have a log Pow of between 0.7 to 1.35.

According to some embodiments the above drinkable article comprises between 70% to 100% of the plurality of innate aroma compounds of the alcoholic beverage the drinkable article is prepared from. According to some embodiments the above drinkable article comprises at least 70%, 75%, 80%, 85%, 90%, 95%, 98%, 99% or 100% of the plurality of innate aroma compounds of the alcoholic beverage the drinkable article is prepared from.

According to some embodiments the invention provides a process for the preparation of a drinkable article according to one or more of the above embodiments.

According to some embodiments, the above drinkable articles have an improved taste when compared to the commercially available low/no alcoholic beverage. According to some embodiments, the improved taste of the above drinkable articles is attributed to selective recovery of the innate aroma compounds. According to some embodiments, the selective recovery of aroma compounds allows controlling the proportion and/or amount according to the identity of the specific innate aroma compounds added back to the non-alcoholic/low alcoholic beverages, thus resulting in better taste and improved drinking experience.

According to some embodiments the invention provides a process for the preparation of a drinkable article having 0.045% ethanol by volume or less, from an alcoholic beverage comprising a plurality of innate aroma compounds.

According to some embodiments the above process comprises the steps of:
a. recovering the plurality of innate aroma compounds from the alcoholic beverage; and
b. preparing the drinkable article comprising the plurality of innate aroma compounds from the alcoholic beverage,
   wherein the step of recovering the plurality of aroma compounds from the alcoholic beverage comprises at least a pre-concentration and a concentration steps, wherein the pre-concentration step comprises preparing a pre-concentrate comprising the plurality of aroma compounds from a starting material originating from the alcoholic beverage; and, wherein the concentration step comprises preparing a concentrate comprising the plurality of aroma compounds from the pre-concentrate; and wherein each of the pre-concentration and the concentration steps comprises at least one cycle of: adsorption on a column loaded with an adsorbent agent that binds the plurality of innate aroma compounds; and, desorption of the plurality of innate aroma compounds from the column with a desorption agent; and,
   wherein the methanol content of the drinkable article is at least 100 times lower than the methanol content of the alcoholic beverage, and wherein the drinkable article comprises at least 70% of the plurality of innate aroma compounds of the alcoholic beverage.

According to some embodiments the invention provides a process for the preparation of a drinkable article according to one or more of the above embodiments, comprising the steps of:
a. providing a starting material having at most 40% ethanol by volume, wherein the starting material originates from an alcoholic beverage and comprises a plurality of innate aroma compounds of the alcoholic beverage;
b. preparing a pre-concentrate comprising the plurality of innate aroma compounds, wherein preparing the pre-concentrate comprises at least one cycle of:
   i. adsorbing the starting material on a column loaded with an adsorbent agent that binds the plurality of innate aroma compounds; and,
   ii. desorbing of the adsorbed aroma compounds from the column with a desorption agent to obtain a pre-concentrate comprising the plurality of innate aroma compounds;
c. preparing a concentrate comprising the plurality of innate aroma compounds, wherein preparing the concentrate comprises at least one cycle of:
   i. diluting the pre-concentrate of step “b-ii” to less than 40% ethanol by volume to obtain a diluted pre-concentrate comprising the plurality of innate aroma compounds;
   ii. adsorbing the diluted pre-concentrate on a column loaded with an adsorbent agent that binds the plurality of innate aroma compounds; and,
   iii. desorbing the adsorbed plurality of innate aroma compounds aroma compounds from the column with a desorption agent to obtain a concentrate; and,
d. preparing drinkable article from the concentrate of step “c-iii”.

According to some embodiments the invention provides a process for the preparation of a drinkable article having a reduced content of at least one harmful volatile compound and 0.045% ethanol by volume or less from an alcoholic beverage, comprising the steps of:
a. providing a starting material having at most 40% ethanol by volume, wherein the starting material originates from an alcoholic beverage and comprises a plurality of innate aroma compounds of the alcoholic beverage;
b. preparing a pre-concentrate comprising the plurality of innate aroma compounds, wherein preparing the pre-concentrate comprises at least one cycle of:
   i. adsorbing the starting material on a column loaded with an adsorbent agent that binds the plurality of innate aroma compounds; and,
   ii. desorbing of the adsorbed aroma compounds from the column with a desorption agent to obtain a pre-concentrate comprising the plurality of innate aroma compounds;
c. preparing a concentrate comprising the plurality of innate aroma compounds, wherein preparing the concentrate comprises at least one cycle of:
   i. diluting the pre-concentrate of step “b-ii” to less than 40% ethanol by volume to obtain a diluted pre-concentrate comprising the plurality of innate aroma compounds;
   ii. adsorbing the diluted pre-concentrate on a column loaded with an adsorbent agent that binds the plurality of innate aroma compounds;
   iii. desorbing the adsorbed plurality of innate aroma compounds aroma compounds from the column with a desorption agent to obtain a concentrate;
      wherein the harmful compound is from the group consisting of methanol, ethyl carbamate, and acetaldehyde, and wherein the content of said harmful compound is at least 10 times lower than the content of said harmful compounds in the alcoholic beverage.

According to some embodiments of the above drinking articles and processes, the process additionally comprises a step of measuring MeOH concentration, EtOH concentration, EtAc concentration, VOC(20) concentration, Hexanoic acid concentration, Phenylethyl Alcohol concentration, Octanoic acid concentration, Nonanoic acid concentration, Decanoic acid concentration, or any combination thereof.

According to some embodiments of the above drinking articles and processes, the content of said harmful compound is at least 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 or more, lower than the content of said harmful compounds in the alcoholic beverage.

According to some embodiments, the invention provides a concentrate for the preparation of the drinkable article according to one or more of the above embodiments, wherein the concentrate is prepared from an alcoholic beverage, and wherein the concentrate comprises a plurality of innate aroma compounds of the alcoholic beverage; and wherein the contents of harmful volatile compounds selected from methanol, ethyl carbamate, and acetaldehyde in the concentrate is at least 10 times lower than in the alcoholic beverage.

According to some embodiments of the above concentrate, the content of said harmful compound is at least 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 or more, lower than the content of said harmful compounds in the alcoholic beverage.

According to some embodiments, the invention provides a concentrate for the preparation of the drinkable article according to one or more of the above embodiments, wherein the concentrate is prepared from an alcoholic beverage, and wherein the concentrate comprises at least 70% of the plurality of innate aroma compounds of the alcoholic beverage. According to some embodiments the above concentrate comprises at least 70%, 75%, 80%, 85%, 90%, 95%, 98%, 99% or 100% of the plurality of innate aroma compounds of the alcoholic beverage the drinkable article is prepared from.

According to some embodiments, the invention provides a process for the preparation of the concentrate according to one or more of the above embodiments, comprising the steps of
a. providing a starting material having at most 40% ethanol by volume, wherein the starting material originates from an alcoholic beverage and comprises a plurality of innate aroma compounds of the alcoholic beverage;
b. preparing a pre-concentrate comprising the plurality of innate aroma compounds, wherein preparing the pre-concentrate comprises at least one cycle of:
   i. adsorbing the starting material on a column loaded with an adsorbent agent that binds the plurality of innate aroma compounds; and,
   ii. desorbing of the adsorbed aroma compounds from the column with a desorption agent to obtain a pre-concentrate comprising the plurality of innate aroma compounds; and,
c. preparing the concentrate comprising the plurality of innate aroma compounds, wherein preparing the concentrate comprises at least one cycle of:
   i. diluting the pre-concentrate of step “b-ii” to less than 40% ethanol by volume to obtain a diluted pre-concentrate comprising the plurality of innate aroma compounds;
   ii. adsorbing the diluted pre-concentrate on a column loaded with an adsorbent agent that binds the plurality of innate aroma compounds;
   iii. desorbing the adsorbed plurality of innate aroma compounds aroma compounds from the column with a desorption agent to obtain a concentrate.

According to some embodiments of the above drinkable articles, concentrates and processes, the non-limiting list of alcoholic beverages includes: red wine, white wine, rose wine, champagne, rice wine, fruit wine, metaxa, cider, beer, mead, ale, spirits, martini, whiskey, brandy, liquor, rum, cherry brandy, calvados, cachaca, arrack, sake, raki, Midori, feigling, curacao, schnapps, cognac, Armagnac, pisco, tequila, mezcal, grappa, raki, fruit spirit, Shochu, soju, Tiswin, Toddy, Tonto, Tuica, Ogogoro, Palinka, Plum Jerkum, Piotin, Pulque, Port, Sherry, Kvass, Chicha, Bijiu, Medronho, pina colada, Ouzo, Aquavit, Absinthe, Gin, or any combination thereof.

According to some embodiments of the above drinkable articles, concentrates and processes, the starting material, may be, without limitation, an undiluted alcoholic beverage, a diluted alcoholic beverage, an alcohol-containing fraction of the alcoholic beverage; a filtered alcoholic beverage; and a diluted alcohol-containing fraction of the alcoholic beverage. For example, a distillate of an alcoholic beverage having, without limitation, 50% or more ethanol by volume can be diluted to at most 40% ethanol by volume to serve as a starting material.

According to some embodiments of the above drinkable articles, concentrates and processes, the process additionally comprises a step of measuring MeOH concentration, EtOH concentration, EtAc concentration, innate VOC(20) concentration, innate median VOC(20), Hexanoic acid concentration, Phenylethyl Alcohol concentration, Octanoic acid concentration, Nonanoic acid concentration, Decanoic acid concentration, or any combination thereof.

According to some embodiments of the above drinkable articles, concentrates and processes, the process additionally comprises a step of measuring favor of the drinkable articles and/or concentrates. According to some embodiments, the step of measuring favor comprises measuring at least one characteristic of the drinkable articles and/or concentrates, selected from floral, acidity, sourness, fruity, sweet, green, sulfur, alcoholic, green or any combination thereof.

According to some embodiments of the above drinkable articles, concentrates and processes, the process additionally comprises a step of removing the Ethanol from the alcoholic beverage by any known technology or method, and collecting the aroma containing fraction. In some embodiments, the EtOH is removed using vacuum distillation.

In the context of the invention, the term “alcoholic beverage” is interchangeable with terms “adult beverage”, “alcoholic drink”, “strong drink”, or “a drink”, and refers, without limitation, to a drink that contains ethanol, a type of alcohol that acts as a drug and is produced by fermentation of grains, fruits, or other sources of sugar. A non-limiting list of alcoholic drinks according to one or more above and foregoing embodiments includes red wine, white wine, rose wine, champagne, rice wine, fruit wine, metaxa, cider, beer, mead, ale, spirits, martini, whiskey, brandy, liquor, rum, cherry brandy, cognac, Armagnac, calvados, cachaca, arrack, sake, raki, Midori, feigling, curacao, schnapps, pisco, tequila, mezcal, grappa, raki, fruit spirit, Shochu, soju, Tiswin, Toddy, Tonto, Tuica, Ogogoro, Palinka, Plum Jerkum, Piotin, Pulque, Port, Sherry, Kvass, Chicha, Bijiu, Medronho, pina colada, Ouzo, Aquavit, Absinthe, Gin, or any combination thereof.

In the context of the invention the term “aroma compounds” (also referred to as odorants, aroma, fragrances, or flavoring) refers, without limitation, to chemical compounds or substances that have a smell or odor. The aroma compounds affect the sensory impression of a beverage, mainly the flavor and aroma. Many aroma compounds can also be referred to as volatile organic compounds (VOC), as being sufficiently volatile to access the olfactory system. Many of the aroma compounds in alcoholic beverages are, without limitation, a product of fermentation process and/or an aging process. A non-limiting list of aroma compounds in drinkable articles, pre-concentrates, concentrates and starting material of the invention includes geraniol, (Z)-3-hexenal, beta-ionone, (R)-linalool, myrcene, nonanal, (R)-a-pinene, ethyl 3-methylbutanoate, hexanal, 1,8-cineole, ethyl acetate, butyric acid ethyl ester, isobutanol, isoamyl acetate, 2-methylbutan-1-ol, 3-methylbutan-1-ol, ethyl hexanoate, 2-phenylethyl acetate, 2-phenylethanol, or any combination thereof.

The term “adsorption” is understood to refer to the adhesion of compounds from a liquid or a gas, or a solid dissolved in a liquid to a surface, producing an adsorbate on the surface of the adsorbent agent. The term adsorption agent (also referred to as a sorption agent or an adsorbent) refers to an insoluble material that can bind an amount of a compound. Adsorbents are often characterized as oxygen-containing compounds, carbon-based compounds, or polymer-based compounds.

According to some embodiments of the above invention the adsorption step is performed at a temperature of <50° C. According to some embodiments of the above invention the adsorption step is performed at a temperature of <25° C.

According to some embodiments of the above invention the adsorption is performed at a pressure of 1-to-5 bar.

As used herein, the term “desorption” is understood to refer to a process where the adsorbed compounds are released from a surface into the surrounding vacuum or liquid. Desorption is considered as the reverse of adsorption.

According to some embodiments of the above invention the desorption solution is selected from the group consisting of a distillate fraction, an alcohol fraction, an ethanol-water solution, water, steam, or any combination thereof.

In some embodiments, the ethanol-based solution comprises at least 50% ethanol or alcohol in water. According to some embodiments of the above invention the desorption solution comprises 70% to 96% ethanol or alcohol. According to some embodiments of the above invention, desorption with an ethanol-containing solution is performed at a temperature of >10° C. According to some embodiments of the above invention, desorption with an ethanol-containing solution is performed at a temperature of >50° C. According to some embodiments of the above invention, desorption with an ethanol-containing solution is performed at a temperature of 50-to-80° C.

According to some embodiments of the above invention, desorption with water is performed at a temperature of >25° C. According to some embodiments of the above invention the desorption with water is performed at a temperature of >50° C. According to some embodiments of the above invention, desorption with water is performed at a temperature of 50-to-135° C.

According to some embodiments of the above invention the desorption solution is characterized as steam.

According to some embodiments of the above invention, desorption step is performed at a pressure of <1 bar.

According to some embodiments of the above invention the at least one column has a length of at least 3000 mm. According to some embodiments of the above invention the column has a length of 3000 to 7000 mm. The column can have a length of 3200 mm, 3400 mm, 3600 mm, 3800 mm, 4000 mm, 4200 mm, 4400 mm, 4600 mm, 4800 mm, 5000 mm, 5200 mm, 5400 mm, 5600 mm, 5800 mm, 6000 mm, 6200 mm, 6600 mm, or 6800 mm.

According to some embodiments of the above invention the at least one column has a width of less than 500 mm. According to some embodiments of the above invention the column has a width of less than 250 mm.

According to some embodiments of the above invention the at least one column has a width of 5 to 250 mm. According to some embodiments of the above invention the column has a width of 15 mm, 25 mm, 35 mm, 50 mm, 75 mm, 100 mm, 125 mm, 150 mm, 175 mm, 200 mm, or 225 mm.

According to some embodiments of the above invention the column has a volume of at least 5 liters.

According to some embodiments of the above invention the at least one column has a volume of 5 to 500 liters. According to some embodiments of the above invention the column has a volume of 10, 15, 25, 50, 75, 100, 125, 150, 175, 200, 250, 300, 350, 400, or 450 liters.

According to some embodiments of the above invention the at least one column has a length-to-width ration of 10-to-1 to 5000-to-1. According to some embodiments of the above invention the column has a length-to-width ration of 15-to-1, 25-to-1, 50-to-1, 75-to-1, 100-to-1, 150-to-1, 200-to-1, 250-to-1, 500-to-1, 750-to-1, 1000-to-1, 1250-to-1, 1500-to-1, 1750-to-1, 2000-to-1, 2250-to-1, 2500-to-1, 2750-to-1, 3000-to-1, 3250-to-1, 3500-to-1, 3750-to-1, 4000-to-1, 4250-to-1, 4500-to-1, 4750-to-1, or 5000-to-1.

As used herein, the term “Log Pow” (also referred to as P or K_{OW}) refers to the n-octanol-water partition coefficient of a compound. The P partition coefficient for a two-phase system of n-octanol and water. Log P can be determined experimentally or estimated using various predictive models.

### Procedure A—GC-MS Methodology for Measuring Methanol Content

Labeled methanol (Methanol-d₃—Sigma Aldrich; 343854-1G) was used to measure methanol content in alcoholic and non-alcoholic wine samples.

In addition, the limit of detection (LOD) has been determined.

### Sample Preparation for Analysis

1 ml of Dichloromethane (for HPLC≥99.8%, Sigma-Aldrich) and 100 μl of sample were mixed in 1.5 ml glass vial.
25 μl of methanol-d3 0.1% was added as internal standard to this mixture.
This solution was homogenized before the injection. Each sample was analyzed twice.

### GC/MS Method Parameters:

Chromatographic separation was carried out using a model GC-2010 Plus gas chromatograph (Shimadzu, Tokyo, Japan), with an Optima 5 MS Accent column, from of 30 m×0.25 mm, and 0.25 m (Macherey-Nagel, Germany). Helium (Air Liquide, France) was used as a carrier gas (purity ≥99.999%), with a gas flow rate of 1.00 mL/min. The injection temperature was held at 230° C. The samples were injected in the split mode (1:25 ratio) by using liquid injection. The column temperature started at 35° C. and was held for 3 min. A mass spectrometer detector, model GCMS-QP2020 (Shimadzu, Tokyo, Japan), with an electron impact ionization source of 70 eV, was used. The temperatures of the MS source and MS transfer line were set at 200° C. and 230° C., respectively. The data acquisition was carried out by SIM mode monitoring the ions 29, 30, 31, 33, 35, 45, 46, 48 and 49 m/z.

Data analysis—Peak area of 31 m/z was used to quantify methanol.

The Limit of Detection (LOD)—the LOD for methanol was determined to be 0.01% (By Volume) in Alcoholic Wine and 0.001% (By Volume) in Dealcoholized Wine

Calibration Curve—the calibration curve was created using standard solutions of 1%, 0.1%, 0.01% and 0.001% by volume methanol. The equation of the calibration curve was: y=a+bx (where y represents the concentration of the substance and x represents the area of the substance in the chromatogram corrected by the internal standard).

### Procedure B: HS-SPME-GC-MS Methodology for Measuring VOC Content

### Sample Preparation (Innate VOC):

Sample preparation alcoholic wine: 9 ml of each sample was mixed with 1 ml of distilled water in a 20 mL vial. 1 ml was added to a 20 ml headspace vial and an Internal standard, 3 μl of a 2,3-Dimethoxytoluene solution (15.6 ppm), was added. The solution was homogenized before SPME extraction. Each sample was analyzed twice.
Sample preparation non-alcoholic wine: 9 ml of each sample was mixed with 1 ml of ethanol in a 20 mL vial. 1 ml of this mixture was added to a 20 ml headspace vial and an Internal standard, 3 μl of a 2,3-Dimethoxytoluene solution (15.6 ppm), was added. The solution was homogenized before SPME extraction. Each sample was analyzed twice.
Sample preparation alcoholic spirits: Each sample was diluted to 10 Vol % of ethanol, with distilled water. 1 ml was placed in a 20 ml headspace vial and an Internal standard, 3 μl of a 2,3-Dimethoxytoluene solution (15.6 ppm), was added. The solution was homogenized before SPME extraction. Each sample was analyzed twice.
Sample preparation non-alcoholic spirits: 9 ml of each sample was mixed with 1 ml of ethanol in a 20 mL vial. 1 ml of this mixture was added to a 20 ml headspace vial and an Internal standard, 3 μl of a 2,3-Dimethoxytoluene solution (15.6 ppm), was added mixture. The solution was homogenized before SPME extraction. Each sample was analyzed twice.

### Volatile Compound Extraction by SPME:

The volatile compound extraction was carried out at 60° C. for 20 min using a solid-phase microextraction (SPME) device (65 μm PDMS/DVB, Fused silica 24 Ga, manual holder, Supelco, Bellefonte, USA). The fiber was conditioned prior to use, as recommended by the commercial company.

### HS-SPME-GC/MS Method Parameters:

### Chromatographic Conditions

The chromatographic separation was carried out using a GC-2010 Plus gas chromatograph (Shimadzu, Tokyo, Japan), with an Optima FFAP Plus column, from of 30 m×0.25 mm, and 0.50 m (Macherey-Nagel, Germany).
Helium (Air Liquide, France) was used as a carrier gas (purity ≥99.999%) with a gas flow rate of 1.47 mL/min. The injection temperature was held at 230° C. The samples were manually injected in the splitless mode. Column temperature started at 35° C. for 2 min; and then increased to 235° C. at a rate of 8° C./min and held at 235° C. for 20 min.
The mass spectrometer detector was a GCMS-QP2020 (Shimadzu, Tokyo, Japan), with an electron impact ionization source of 70 eV. The temperatures of the MS source and MS transfer line were set at 200° C. and 230° C., respectively. The mass range used in the SCAN mode was 29-250 m/z. the detector monitored all compounds from 3.5 to 44.5 minutes.

### Data Analysis:

All volatile organic compounds were monitored in SCAN and reported in peak areas TIC, except the internal standard, which peak area was reported only for m/z 152.
The 30 volatile compounds showing the biggest abundance were extracted from the chromatogram for further analysis. VOC ppm is calculated in ppm DMOT (m/z 154) equivalents, as related to the peak area.
For calculating VOC(20), the peaks associated with ethyl acetate (EtAc), ethanol (EtOH), methanol, methylene chloride, analytical artefacts, or contaminants introduced or generated by or during sample preparation or during sample measurement were omitted and the median of the 20 most abundant VOCs were calculated in ppm DMOT (m/z 154) equivalents.

### EXAMPLES

In the examples below, if an abbreviation is not defined above, it has its generally accepted meaning.

### Example 1: A Process for Recovering Aroma Compounds from an Alcoholic Beverage

The processing is based on solid phase extraction (SPE). The solid phase extraction is carried out in 2 phases—adsorption and desorption.
Phase 1: Adsorption—aroma compounds are collected and concentrated from ethanol/water phases on adsorbent bed. Ethanol/water phase is diluted to an ABV of about 15% and pumped through the adsorbent bed.
Phase 2: Desorption—the aroma compounds are washed down from the sorbent bed with a desorption agent, such as ethanol/distillate ABV above 60%.

The obtained aroma compounds concentrate of the first SPE process run is an interim product and the starting material for a second SPE extraction cycle.

The interim product is diluted with water again to ABV below 15% and processed on a second production equipment with a layout allowing to process small quantities of material.

### Example 2: Preparation of Non-Alcoholic Cachaca

Cachaca was diluted to 10% ABV. The diluted solution was loaded on a resin bed and was pumped at room temperature under the pressure of about 3 bar.

Desorption was conducted with an ethanol solution, at a temperature above 30° C. The adsorption-desorption step was repeated to obtain the pre-concentrate.

The desorption solution (pre-concentrate) was diluted to 10% ABV, was loaded on a resin bed and was pumped at room temperature under the pressure of about 3 bar.

Desorption was conducted with an ethanol solution at a temperature above 30° C. A Concentrate containing innate aroma compounds of Cachaca was collected. Cachaca free of alcohol was prepared using the concentrate.

### Example 3: Preparation of Non-Alcoholic Gin

The Gin (40 ABV) was diluted to 10% ABV. The diluted solution was loaded on a resin bed and was pumped at room temperature under the pressure of about 3 bar. Desorption was conducted with an ethanol solution, at the temperature above 30° C.

The adsorption-desorption step was repeated to obtain the pre-concentrate. The desorption solution (pre-concentrate) was diluted to 10% ABV, was loaded on a resin bed and was pumped at room temperature under the pressure of about 3 bar.

Desorption was conducted with an ethanol solution at a temperature above 30° C. A Concentrate containing innate aroma compounds of gin was collected.

Alcohol-free gin was prepared using the concentrate.

TABLE 1
Analysis of Alcoholic (40% ABV) and Alcohol-free gin (prepared
according to example 3, analyzed according to Procedure
B. The peaks are listed in order of detection.

| Needle Gin Distilled | Needle Gin Alkohol |
|---|---|
| Dry PA (TIC) | frei PA (TIC) |
| 391348 | 139947 |
| 13500869 | 47633182 |
| 17617054 | 140546169 |
| 31789182 | 97519690 |
| 48815647 | 49264818 |
| 22621151 | 43418886 |
| 169137394 | 18651862 |
| 30655688 | 67476290 |
| 71629717 | 623009784 |
| 31662637 | 127840056 |
| 19482363 | 13362782 |
| 13374456 | 191025395 |
| 46496024 | 452931523 |
| 22325615 | 14937956 |
| 12914798 | 604399 |
| 184314879 | 36295886 |
| 26408516 | 150878408 |
| 90705057 | 28128440 |
| 84300023 | 40845753 |
| 16862547 | 34410247 |
| 741758 | 15291309 |
| 14600539 | 124093790 |
| 13700445 | 19815650 |
| 21660883 | 48607843 |
| 55338328 | 14540267 |
| 26301444 | 22135210 |
| 18210578 | 24018399 |

### Example 4: Preparation of Non-Alcoholic Beer

The ethanol was removed from the beer, using vacuum distillation, collecting the Ethanol fraction, containing the EtOH and the volatile organic compounds. The dealcoholized fraction was preserved.

The EtOH fraction was diluted to 10% ABV. The diluted solution was loaded on a resin bed and was pumped at room temperature under the pressure of about 3 bar.

Desorption was conducted with an ethanol solution, at a temperature above 30° C. The adsorption-desorption step was repeated to obtain the pre-concentrate.

The desorption solution (pre-concentrate) was diluted to 10% ABV, was loaded on a resin bed and was pumped at room temperature under the pressure of about 3 bar. Desorption was conducted with an ethanol solution at a temperature above 30° C. A Concentrate containing innate aroma compounds of beer was collected.

Alcohol-free beer was prepared using the concentrate and the dealcoholized fraction.

### Example 5: Preparation of Non-Alcoholic Wine

The ethanol was removed from the wine, using vacuum distillation, collecting the Ethanol fraction, containing the EtOH and the volatile organic compounds. The dealcoholized fraction was preserved.

The EtOH fraction was diluted to 10% ABV. The diluted solution was loaded on a resin bed and was pumped at room temperature under the pressure of about 3 bar.

Wine was diluted to 10% ABV. The diluted solution was loaded on a resin bed and was pumped at room temperature under the pressure of about 3 bar.

Desorption was conducted with an ethanol solution, at a temperature of at least 30° C.

The adsorption-desorption step was repeated to obtain the pre-concentrate. The desorption solution (pre-concentrate) was diluted to 10% ABV, was loaded on a resin bed and was pumped at room temperature under the pressure of about 3 bar.

Desorption was conducted with an ethanol solution at a temperature of at least 30° C.

A Concentrate containing innate aroma compounds of wine was collected. Wine free of alcohol was prepared by combining the aroma containing concentrate and the dealcoholized fraction.

The process was conducted on Craft N. Mediterranee (Table 2) and Craft Novel le Verdejo Eco Dep 27 (Table 3).

TABLE 2
Wine: Craft N. Mediterranee, prepared according
to Example 5 analyzed according to Procedure
B. The peaks are listed in order of detection.

| Alcohol wine (TIC) | Alcohol free wine (TIC) |
|---|---|
| 65475219 | 10308561 |
| 9864753 | 6624304 |
| 8496800 | |
| 91596861 | 113514260 |
| 198715006 | 61352704 |
| | 9949428 |
| 120681840 | 121883395 |
| 31525008 | 39232068 |
| 11269989 | 12109606 |
| | 2906749 |
| 613029704 | 196951690 |
| 5512519 | 4634458 |
| | 1121004 |
| 472231403 | 26619383 |
| 3235141 | |
| 822827 | 1057964 |
| 8266132 | 8452911 |
| 3879624 | |
| 57828830 | 3652407 |
| 16440663 | 21463067 |
| 15582377 | 18948876 |
| 71939622 | 88501357 |
| 19086767 | 4679702 |
| 154545737 | 166038639 |
| 26553458 | 150563986 |
| 135419789 | 128844765 |
| 38181334 | 23999691 |

TABLE 3
Craft Novel le Verdejo Eco Dep 27, prepared according
to Example 5, analyzed according to Procedure B.
The peaks are listed in order of detection.

| Starting Wine | Dealcoholized | Alcohol-free |
|---|---|---|
| (TIC) | fraction (TIC) | wine (TIC) |
| 50472680 | | 6276355 |
| 8816069 | | |
| 6163110 | | |
| 59936819 | | 48483647 |
| 174688555 | 7417056 | 54462721 |
| | 12473092 | 7447327 |
| 106295798 | 6136821 | 45006119 |
| 6766619 | | 5702653 |
| 4499355 | 5933195 | 5042995 |
| 9096450 | | 7029806 |
| | 18131033 | 18144676 |
| 569832484 | 51039018 | 84238396 |
| 5342822 | 2632890 | |
| 6448646 | 8619879 | |
| 7716327 | 7046172 | 3892508 |
| | 5655672 | 5829817 |
| 324638177 | 12023930 | 63066432 |
| 854037 | 586465 | 865520 |
| 21267123 | 12821010 | 20145931 |
| 13423650 | | |
| 9570563 | | 6486954 |
| 24674096 | 16442478 | 18185426 |
| | | 12756900 |
| 50004055 | 58863742 | 45934667 |
| 4200867 | 53609933 | 4182727 |
| 154523883 | 99085682 | 228156437 |
| 33421879 | 296009820 | 173992673 |
| 123564163 | 31331659 | 168493658 |
| 48082602 | 83508419 | 13047812 |

### Example 6: Evaluating Ethyl Acetate detection in Non-Alcoholic wine and its effect on aroma

A panel of potential participants were identified, based on their ability to describe sensory perceptions. The candidates were prepared using different olfactory stimuli and trained in the use of scales and in the development and use of descriptors (profiles) as described in DIN EN ISO 8586:2014-05.

A panel of 5 people between 30 and 50 years old were selected.

### 1. Sensory Method Description

The test was carried out according to ISO 8587, with Ethyl acetate was used as stimuli for odour. Six samples having different concentrations of ethyl acetate in non-alcoholic wine (25, 50, 77, 100 and 200 ppm, in addition to a sample with no additional Ethyl Acetate) were prepared. The samples were presented to the panelists in wine glasses in a random order. After the panelists tasted the samples, they were asked to put them in order of increased intensity and to describe the perceived aroma profile.

### 2. Sensory Analysis Results

Table 4 shows the samples prepared.

| | | Alcohol | | | | | |
|---|---|---|---|---|---|---|---|
| | | free | | | | | |
| | Starting | wine | PF + | PF + | PF + | PF + | PF + |
| | wine | (PF) | 25 ppm | 50 ppm | 75 ppm | 100 ppm | 200 ppm |
| EtAc to VOC(20) | 0.13 | 0.02 | 0.10 | 0.22 | 0.28 | 0.32 | 0.48 |
| EtAc-to-Hexanoic acid | 2.8 | 0.3 | 1.5 | 2.5 | 3.4 | 4.4 | 7.2 |
| ratio | | | | | | | |
| EtAc-to-Phenylethyl | 0.9 | 0.1 | 0.5 | 0.9 | 1.2 | 1.5 | 1.8 |
| Alcohol ratio | | | | | | | |
| EtAc-to-Octanoic acid | 0.3 | 0.0 | 0.2 | 0.4 | 0.5 | 0.7 | 1.0 |
| ratio | | | | | | | |
| EtAc-to-Acetic acid | 13.7 | 0.7 | 8.8 | 14.7 | 19.6 | 24.7 | 30.3 |
| ratio | | | | | | | |

### 3. Sensory Analysis Results

The panel indicated that ethyl acetate was unpleasant at concentrations of over 50 ppm in non-alcoholic wine and was described as “glue-like”-off-flavour by 4 of 5 panelists.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

In case of conflict, the patent specification, including definitions, will prevail. In addition, the materials, methods, and examples are illustrative only and are not intended to be necessarily limiting.

As used herein the terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

As used herein, the term “and/or” includes any and all possible combinations or one or more of the associated listed items, as well as the lack of combinations when interpreted in the alternative (“or”).

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

Whenever the term “about” is used, it is meant to refer to a measurable value such as an amount, a temporal duration, and the like, and is meant to encompass variations of ±20%, ±10%, ±5%, ±1%, or ±0.1% from the specified value, as such variations are appropriate to perform the disclosed methods.

Whenever terms “plurality” and “a plurality” are used it is meant to include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, biological, biochemical, and veterinary arts.

Certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

All publications, patent applications, patents, and other references mentioned. The disclosures of these publications in their entireties are hereby incorporated by reference into this application in order to more fully describe the state of the art to which this invention pertains. In case of conflict, the patent specification, including definitions, will prevail. In addition, the materials, methods, and examples are illustrative only and not intended to be limiting. Throughout this application various publications, published patent applications and published patents are referenced.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description. While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention. Various embodiments have been presented. Each of these embodiments may of course include features from other embodiments presented, and embodiments not specifically described may include various features described herein.

Certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A drinkable article characterized in that the drinkable article:
a. is prepared from an alcoholic beverage;
b. comprises 0.045% ethanol or less by volume;
c. has an amount of innate volatile organic compounds (VOC), wherein the amount includes a plurality of innate aroma compounds;
d. has a MeOH content that is:
i. under the detection level, when measured by Procedure A; and/or
ii. less than 0.01% by volume;
and characterized in that
i) the ratio of EtAc to median VOC(20) in the drinkable article is between 1:0.2 and 1:300; and/or
ii) the ratio of EtAc-to-hexanoic acid in the drinkable article is between 1:0.02 to 1:250; and/or
iii) the ratio of EtAc-to-phenylethyl alcohol in the drinkable article is between 1:0.01 to 1:245; and/or
iv) the ratio of EtAc-to-octanoic acid in the drinkable article is between 1:0.3 to 1:300; and/or
v) the ratio of EtAc-to-nonanoic acid in the drinkable article is between 1:0.1 to 1:100; and/or
vi) the ratio of EtAc-to-decanoic acid in the drinkable article is between 1:0.3 to 1:320;
when the EtAc, VOC, and median VOC(20) is measured according to Procedure B;
and characterized in that the drinkable article has no added flavor and/or colorings relative to the alcoholic beverage.

2. The drinkable article of claim 1, wherein the ratio of EtAc to the median VOC(20) is between 1:0.5 and 1:200.

3. The drinkable article of claim 2, wherein the ratio of EtAc to the median VOC(20) is between 1:1 and 1:125.

4. The drinkable article of claim 3, wherein the ratio of EtAc to the median VOC(20) is between 1:3 and 1:50.

5. The drinkable article of claim 4, wherein the ratio of EtAc to the median VOC(20) is between 1:4 and 1:25.

6. The drinkable article of claim 1, further comprising at least 100 ppm of innate total VOC(20).

7. The drinkable article of claim 6, comprising at least 150 ppm of innate total VOC(20).

8. The drinkable article of claim 1, further characterized in having at least 10 innate VOC each at a concentration of at least 1 ppm.

9. The drinkable article of claim 8, further characterized in having at least 10 innate VOC each at a concentration of at least 2 ppm.

10. The drinkable article of claim 8, further characterized in having at least 20 innate VOC each at a concentration of at least 1 ppm.

11. The drinkable article of claim 1, further characterized in that at least a portion of the plurality of innate aroma compounds of the innate VOC have a log Pow of between 0.7 to 1.35.

12. The drinkable article of claim 1, further characterized in that at least a portion of the plurality of innate aroma compounds of the innate VOC in the drinkable article have a log Pow of between 0.7 to 3.5.

13. The drinkable article of claim 11, wherein at least one of the plurality of innate aroma compounds is selected from the group consisting of: geraniol, (Z)-3-hexenal, beta-ionone, (R)-linalool, myrcene, nonanal, (R)-a-pinene, ethyl 3-methylbutanoate, hexanal, 1,8-cineole, ethyl acetate, butyric acid ethyl ester, isobutanol, isoamyl acetate, 2-methylbutan-1-ol, 3-methylbutan-1-ol, ethyl hexanoate, 2-phenylethyl acetate, and 2-phenylethanol.

14. The drinkable article of claim 1, further characterized in that the ethanol content in the drinkable article is 0.001% or less by volume.

15. The drinkable article of claim 1, further characterized in that the alcoholic beverage is a fermented alcoholic beverage.

16. The drinkable article of claim 1, wherein the alcoholic beverage is selected from the group consisting of red wine, white wine, rose wine, sparkling wine, champagne, fruit wine, rice wine, Metaxa, cider, beer, mead, ale, spirits, martini, whiskey, brandy, cognac, Armagnac, liquor, rum, cherry brandy, calvados, cachaca, arrack, sake, raki, Midori, feigling, curacao, schnapps, pisco, tequila, mezcal, grappa, raki, fruit spirit, Shochu, soju, Tiswin, Toddy, Tonto, Tuica, Ogogoro, Palinka, Plum Jerkum, Piotin, Pulque, Port, Sherry, Kvass, Chicha, Bijiu, Medronho, and any combination thereof.

17. The drinkable article of claim 1, further characterized in that the amount of the innate VOC in the drinkable article comprises at least 70% of a plurality of innate aroma compounds in the alcoholic beverage the drinkable article is prepared from.

18. The drinkable article of claim 17, further characterized in that the amount of the innate VOC in the drinkable article comprises at least 90% of a plurality of innate aroma compounds in the alcoholic beverage the drinkable article is prepared from.

19. A process for preparing the drinkable article of claim 1, the process comprising the steps of:
a) providing a starting material originating from alcoholic beverage, wherein said starting material is characterized in that it comprises VOC, wherein the VOC comprises a plurality of innate aroma compounds;
b) preparing a concentrate comprising at least a majority of the plurality of innate aroma compounds;
c) obtaining the drinkable article comprising the amount of VOC comprising the plurality of innate aroma compounds from the concentrate of step (b), and,
d) measuring the amount of VOC and/or VOC(20) and/or median VOC(20) and EtAc in the drinkable article by Procedure B.

20. The process of claim 19, wherein the preparing of the concentrate comprising at least a majority of the plurality of innate aroma compounds of the VOC from the starting material comprises at least one pre-concentration step and at least one concentration step, wherein the pre-concentration step comprises preparing a pre-concentrate comprising the plurality of the innate aroma compounds from the starting material; and, wherein the concentration step comprises preparing a concentrate comprising the plurality of innate aroma compounds from the pre-concentrate; and wherein each of the pre-concentration and the concentration steps comprises at least one cycle of: adsorption on at least one column loaded with an adsorbent agent that binds at least the majority of the plurality of innate aroma compounds; and, desorption of the plurality of innate aroma compounds from the at least one column with a desorption agent.

21. The drinkable article of claim 1, wherein the drinkable article is a spirit, characterized in that:
i) the ratio of EtAc to median VOC(20) is between 1:4 and 1:25; and/or
ii) the ratio of EtAc-to-hexanoic acid is between 1:0.5 to 1:25; and/or
iii) the ratio of EtAc-to-phenylethyl alcohol is between 1:0.3 to 1:15; and/or
iv) the ratio of EtAc-to-octanoic acid is between 1:0.25 to 1:15; and/or
v) the ratio of EtAc-to-nonanoic acid is between 1:0.5 to 1:75; and/or
vi) the ratio of EtAc-to-decanoic acid is between 1:0.2 to 1:5;
when the EtAc and median VOC(20) is measured according to Procedure B.

22. The drinkable article of claim 1, wherein the drinkable article a beer characterized in that
i) the ratio of EtAc to median VOC(20) is between 1:4 and 1:25; and/or
ii) the ratio of EtAc-to-hexanoic acid is between 1:0.5 to 1:25; and/or
iii) the ratio of EtAc-to-phenylethyl alcohol is between 1:0.3 to 1:15; and/or
iv) the ratio of EtAc-to-octanoic acid is between 1:0.25 to 1:15; and/or
v) the ratio of EtAc-to-nonanoic acid is between 1:0.5 to 1:75; and/or
vi) the ratio of EtAc-to-decanoic acid between 1:0.2 to 1:5;
when the EtAc and median VOC(20) is measured according to Procedure B.

23. The drinkable article of claim 1, wherein the drinkable article is wine characterized in that
i) the ratio of EtAc to median VOC(20) is between 1:4 and 1:25; and/or
ii) the ratio of EtAc-to-hexanoic acid is between 1:0.5 to 1:25; and/or
iii) the ratio of EtAc-to-phenylethyl alcohol is between 1:0.3 to 1:15; and/or
iv) the ratio of EtAc-to-octanoic acid is between 1:0.25 to 1:15; and/or
v) the ratio of EtAc-to-nonanoic acid is between 1:0.5 to 1:75; and/or
vi) the ratio of EtAc-to-decanoic acid is between 1:0.2 to 1:5;
when the EtAc and median VOC(20) is measured according to Procedure B.
